(19) United States
(12) Patent Application Publication
(10) Pub. No.: US 2026/0356650 A1
(43) Pub. Date: Nov. 12, 2026

(54) DOSING SYSTEM INCLUDING UPPER SECTION, LOWER SECTION, PLATE AND INSERT, METHOD OF FORMING THEREOF, SPRING-LOADED SLIDE DOSER INCLUDING PLATE AND INSERT

(71) Applicant: Altria Client Services LLC, Richmond, VA (US)

(72) Inventor: Dwight David WILLIAMS, Powhatan, VA (US)

(73) Assignee: Altria Client Services LLC, Richmond, VA (US)

(21) Appl. No.: 19/571,865

(22) Filed: Mar. 19, 2026

Related U.S. Application Data
(60) Provisional application No. 63/774,591, filed on Mar. 19, 2025.

(51) Int. Cl. B67C 11/04

(52) U.S. Cl. CPC B67C 11/04

(57) ABSTRACT

The dosing system includes an upper section having a top surface and a bottom surface, a lower section configured to be coupled to the upper section, a plate, and an insert. The top surface is configured to be coupled to a hopper. The bottom surface defines a recessed portion and a biasing member is housed within the recessed portion. The lower section including a slot such that the plate is configured to be received by the slot and move along the slot. Then insert is received by the recessed portion. The insert is spring loaded against the plate via the biasing member.

### CROSS-REFERENCE TO RELATED APPLICATION

The present application claims priority benefit of U.S. Provisional Patent Application No. 63/774,591, filed on Mar. 19, 2025, the disclosure of which is incorporated herein by reference in its entirety.

### BACKGROUND

### Field

The present disclosure relates to dosing systems, and more particularly to spring loaded slide dosers.

### Description of Related Art

Some products, including some consumer goods, include packaged portions of a compressible material. In some cases, such portioned instances may be produced based on portioning a relatively large, or bulk, instance of the material into multiple smaller portioned instances and packaging the portioned instances. Through the process, the material may escape and stick between components of the system, which creates issues requiring the assembly to be taken apart and cleaned frequently. Accordingly, it is desired to have a system that provides a clearance that can be increased or decreased as needed, while maintaining a constant pressure, thus reducing sticking caused by escaped filler material or buildup.

### SUMMARY

In an example embodiment, a dosing system is provided. The dosing system includes an upper section having a top surface and a bottom surface, a lower section configured to be coupled to the upper section, a plate, and an insert. The top surface is configured to be coupled to a hopper. The bottom surface defines a recessed portion and a biasing member is housed within the recessed portion. The lower section including a slot such that the plate is configured to be received by the slot and move along the slot. Then insert is received by the recessed portion. The insert is spring loaded against the plate via the biasing member.

In various embodiments, the recessed portion includes a plurality of biasing members.

In various embodiments, the slot has a lateral clearance of 5-10 mm.

In various embodiments, the biasing member is configured to allow the insert to compress into the recessed portion such that the insert is flush with the bottom surface.

In various embodiments, the dosing system further includes a material surrounding a bottom surface of the plate. The bottom surface is in confronting relation with the lower section.

In various embodiments, the material includes a polyethylene terephthalate.

In various embodiments, the dosing system further includes an air cylinder coupled to the plate. The air cylinder is configured to move the plate in a reciprocating manner.

In various embodiments, the air cylinder is configured to reciprocate the plate 30 mm.

In various embodiments, the air cylinder is configured to reciprocate the plate 50-100 times per minute.

In various embodiments, the insert includes a Polyether ether ketone (PEEK), an A2 tool steel, a D2 tool steel, or a diamond coating.

In various embodiments, the upper section includes a first channel configured to receive a filler material from the hopper and the lower section includes a second channel configured to receive the filler material from the upper section.

In various embodiments, the plate is configured to control flow of the filler material from the first channel to the second channel.

In various embodiments, the lower section includes packaging to receive the filler material.

In another example embodiment, a spring-loaded slide doser is provided. The spring-loaded slid doser includes a top stationary plate defining a recessed portion in a first surface, a biasing member housed within the recessed portion, a plate configured to slide horizontally with respect to the top stationary plate, and an insert configured to be received by the recessed portion and biased against the plate via the biasing member.

In various embodiments, the spring-loaded slide doser further includes a bottom stationary plate.

In various embodiments, the bottom stationary plate includes a slot configured to receive the plate.

In various embodiments, the spring-loaded slide doser further includes a plurality of biasing members housed within the recessed portion.

In various embodiments, the biasing member is configured to allow the insert to compress into the recessed portion such that the insert is flush with the top stational plate.

In various embodiments, the insert includes a Polyether ether ketone (PEEK), an A2 tool steel, a D2 tool steel, or a diamond coating.

In various embodiments, the top stationary plate includes a first channel configured to receive a filler material from a hopper and the bottom stationary plate includes a second channel configured to receive the filler material from the top stationary plate.

In various embodiments, the plate is configured to control flow of the filler material from the first channel to the second channel.

In yet another example embodiment, a method of forming a dosing system is provided. The method includes providing an upper section having a top surface and a bottom surface, forming a recessed portion in the bottom surface, providing a biasing member disposed within the recessed portion, providing a lower section configured to be coupled to the upper section, the lower section including a slot, providing a plate configured to be received by the slot and move along the slot, providing an insert received by the recessed portion, and coupling the top surface to a hopper. The insert is spring loaded against the plate via the biasing member.

In various embodiments, forming the recessed portion includes forming the recessed portion via electrical discharge machining.

In various embodiments, forming the recessed portion includes forming the recessed portion via computer numerical control machining.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a perspective view of a dosing system, according to some example embodiments;

FIG. 2 is a side cross-sectional view along line III-III′ of the dosing system of FIG. 1, according to some example embodiments;

FIG. 3 is a schematic diagram view of the dosing system of FIG. 1, according to some example embodiments;

FIG. 4 is a schematic diagram view of the dosing system of FIG. 1, according to some example embodiments;

FIG. 5 is a schematic diagram view of the dosing system of FIG. 1, according to some example embodiments;

FIG. 6 is a schematic diagram view of an upper assembly of the dosing system of FIG. 1, according to some example embodiments;

FIG. 7 is a schematic diagram view of an insert of the dosing system of FIG. 1, according to some example embodiments;

FIG. 8 is a schematic diagram view of the insert of the dosing system of FIG. 7, according to some example embodiments; and

FIG. 9 is a flowchart illustrating a method of forming a dosing system, according to some example embodiments.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that precision of the geometric shape is not required but that latitude for the shape is within the scope of the disclosure. Although channels and/or conduits described herein may be illustrated and/or described as being cylindrical, other channel and/or conduit cross-sectional forms are contemplated, such as square, rectangular, oval, triangular and others.

Referring generally to the figures, an apparatus (e.g., a spring-loaded slide doser) for filling a package with filler (e.g., a powder) is provided. The apparatus includes a plate positioned between an upper stationary plate and a lower stationary plate. The plate is configured to move, or reciprocate, which coupled to an air cylinder, for example. Filler may be poured through the upper stationary plate and the plate into the lower stationary plate, which may include a package for the filler or the package may be below the lower stationary plate. The plate is configured to slide horizontally, thus controlling whether the filler may flow through the plate. Springs extending from the bottom side of the upper stationary plate are configured to bias an insert against the top surface of the plate, such that the plate may move freely while minimizing space between the upper and lower stationary plates.

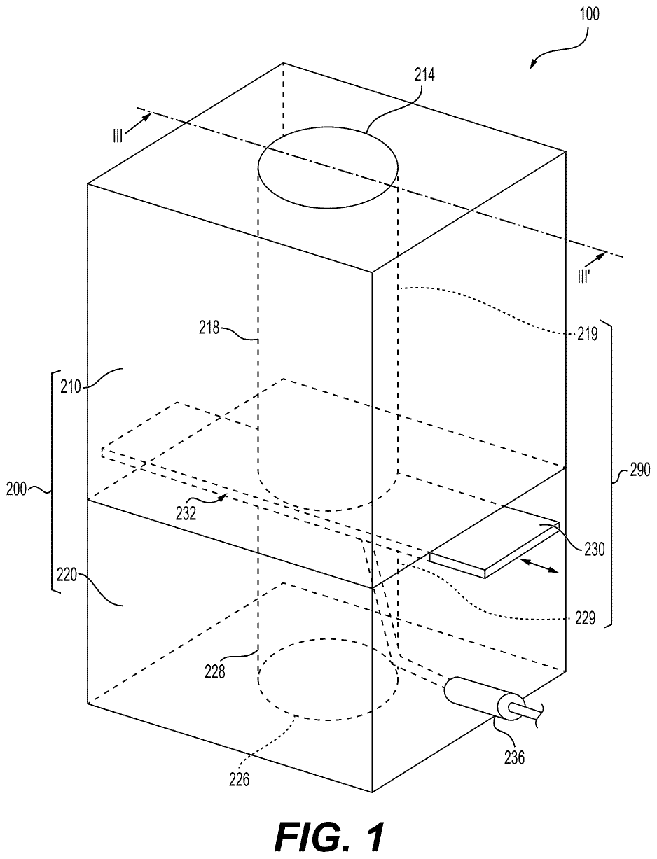

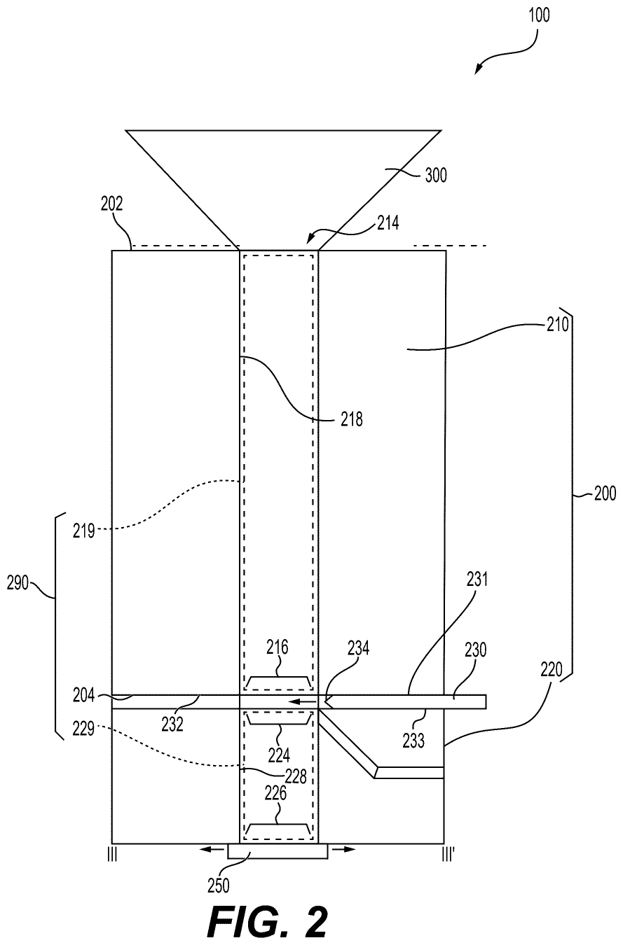

Referring now to FIGS. 1-2, a dosing system 100 is illustrated. Particularly, the dosing system 100 includes a channel assembly 200 and a cutting assembly 230, according to some example embodiments.

In some example embodiments, the dosing system 100 includes a channel assembly that includes an upper assembly and a lower assembly, where the upper assembly includes an upper inner surface defining an upper channel, the lower assembly includes a lower inner surface defining a lower channel, the upper inner surface and the lower inner surface collectively at least partially define a continuous channel including the upper and lower channels, the upper assembly defines a top opening of the continuous channel, and the lower assembly defines a bottom opening of the continuous channel. For example, channel assembly 200 includes an upper assembly 210 (e.g., an upper section, a top stationary plate) and a lower assembly 220 (e.g., a lower section, a bottom stationary plate). Upper assembly 210 includes an upper inner surface 218 defining an upper channel 219 (e.g., a first channel), and the lower assembly 220 includes a lower inner surface 228 defining a lower channel 229 (e.g., a second channel). As shown in FIG. 2 for example, the upper inner surface 218 and the lower inner surface 228 collectively at least partially define a continuous channel 290 that includes the upper channel 219 and the lower channel 229.

As further shown in FIGS. 1-2, the upper assembly 210 defines a top opening 214 and a bottom opening 216 of the upper channel 219, and the lower assembly 220 defines a top opening 224 and a bottom opening 226 of the lower channel 229. The bottom opening 216 and the top opening 224 are proximate to and in fluid communication with each other, such that the upper channel 219 and the lower channel 229 are in continuous fluid communication with each other and thus collectively at least partially define a continuous channel 290. The top opening 214 defines a top opening of the continuous channel 290, and thus the upper assembly 210 defines top opening 214 as the top opening of the continuous channel 290. The bottom opening 226 defines a bottom opening of the continuous channel 290, and thus the lower assembly 220 defines a bottom opening of the continuous channel 290.

As shown in FIG. 2, the channel assembly 200 may be coupled to a hopper 300. For instance, the hopper 300 may be aligned with the top opening 214 of the upper assembly 210 such that the upper channel 219 of the upper assembly 210 is configured to receive a material, a filler, or a filler material, from the hopper 300. Further, the lower channel 229 of the lower assembly 220 is configured to receive the material, filler, or filler material, from the upper assembly 210.

In some example embodiments, a channel assembly may be configured to hold a bulk instance of a compressible material or compressible filler material extending continuously through both the upper channel and the lower channel. For example, the channel assembly 200 may hold a bulk instance of a compressible material that extends continuously through the continuous channel 290 to thus extend continuously through both the upper channel 219 and the lower channel 229. Hereinafter, material or filler material will be referred to as filler material.

As described herein, the filler material may include particulate matter comprising particles. The filler material may be a powder-like substance that may flow freely when shaken or tilted. In some example embodiments, the filler material may have a particle size (e.g., particle diameter) between about 0.1 μm to about 500 μm. In some example embodiments, the filler material may have a particle size (e.g., particle diameter) between about 0.1 μm to about 200 μm. In some example embodiments, the filler material may have a particle size between about 0.5 mm to about 1 mm, about 0.25 mm to about 0.5 mm, about 125 μm to about 250 μm, about 60 μm to about 125 μm, about 4 μm to about 60 μm, about 1 μm to about 4 μm, any combination thereof, or the like.

In some example embodiments, the filler material may have an average particle size of about 50 μm. In some example embodiments, the filler material may have an average particle size of about 200 μm. In some example embodiments, the filler material may have an average particle size of about 400 μm.

The filler material may partially or entirely comprise particles having a maximum diameter that is between about 0.1 μm to about 1 μm. The filler material may partially or entirely comprise particles having a maximum diameter that is equal to or greater than 1 μm.

The filler material may contain and/or partially or completely comprise at least one substance. In some example embodiments, the at least one substance is a consumer product.

In some example embodiments, the at least one substance and/or the consumer product is an inert powder material. In some example embodiments, the filler material may contain and/or partially or completely comprise a substance that is microcrystalline cellulose (MCC).

In some example embodiments, the at least one substance and/or the consumer product includes (e.g., partially or completely comprises) an oral product.

In some example embodiments, the oral product is an oral tobacco product, an oral non-tobacco product, an oral Cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

The oral product may include chewing tobacco, snus, moist snuff tobacco, dry snuff tobacco, other smokeless tobacco and non-tobacco products for oral consumption, or any combination thereof.

Where the oral product is an oral tobacco product including smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In some example embodiments, the oral product includes a tobacco extract, such as a tobacco-derived nicotine extract, and/or synthetic nicotine. The oral product may include nicotine alone or in combination with a carrier (e.g., white snus), such as a cellulosic material. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least 25%, 40%, 50%, 60%, 70%, 75%, 80%, 85%, 90%, or 95% of the nicotine. For example, the tobacco plant tissue can be washed with water or another solvent to remove the nicotine.

In other example embodiments, the oral product may include Cannabis, such as cannabis plant tissue and/or cannabis extracts. In some example embodiments, the cannabis material includes leaf and/or flower material from one or more species of cannabis plants and/or extracts from the one or more species of Cannabis plants. The one or more species of Cannabis plants may include Cannabis sativa, Cannabis indica, and/or Cannabis ruderalis. In some example embodiments, the Cannabis may be in the form of fibers. In some example embodiments, the Cannabis may include a cannabinoid, a terpene, and/or a flavonoid. In some example embodiments, the Cannabis material may be a Cannabis-derived Cannabis material, such as a Cannabis-derived cannabinoid, a Cannabis-derived terpene, and/or a Cannabis-derived flavonoid.

The oral product (e.g., the oral tobacco product, the oral non-tobacco product, or the oral Cannabis product) may have various ranges of moisture. In some example embodiments, the oral product is a dry oral product having a moisture content ranging from 5% by weight to 10% by weight. In some example embodiments, the oral product has a medium moisture content, such as a moisture content ranging from 20% by weight to 35% by weight. In some example embodiments, the oral product is a wet oral product having a moisture content ranging from 40% by weight to 55% by weight.

In some example embodiments, oral product may further include one or more elements such as a mouth-stable polymer, a mouth-soluble polymer, a sweetener (e.g., a synthetic sweetener and/or a natural sweetener), an energizing agent, a soothing agent, a focusing agent, a plasticizer, mouth-soluble fibers, an alkaloid, a mineral, a vitamin, a dietary supplement, a nutraceutical, a coloring agent, an amino acid, a chemesthetic agent, an antioxidant, a food-grade emulsifier, a pH modifier, a botanical, a tooth-whitening agent, a therapeutic agent, a processing aid, a stearate, a wax, a stabilizer, a disintegrating agent, a lubricant, a preservative, a filler, a flavorant, flavor masking agents, a bitterness receptor site blocker, a receptor site enhancers, other additives, or any combination thereof.

In some example embodiments, the filler material may contain any product or substance. For example, the filler material may contain confectionary products, food products, medicines, or any other product.

Referring still to FIGS. 1-2, the dosing system 100 may include a cutting assembly 230 (e.g., a plate, a reciprocating plate, a moving plate, etc.). The cutting assembly 230 may be configured to move in relation to the channel assembly 200 to extend transversely through the continuous channel between the upper channel 219 and the lower channel 229 of the channel assembly 200, such that the lower material portion is severed from the upper material portion to establish the lower material portion as the portioned instance, and the cutting assembly 230 isolates the lower channel 229 from the upper channel 219. For example, the cutting assembly 230, or plate, is configured to control flow of the material from the upper channel 219 to the lower channel 229. The severing of the lower material portion from the upper material portion may also be referred to herein as “producing” the portioned instance of the compressible material. In various embodiments, the lower assembly 220 of the dosing system 100 may include packaging configured to receive the lower material portion.

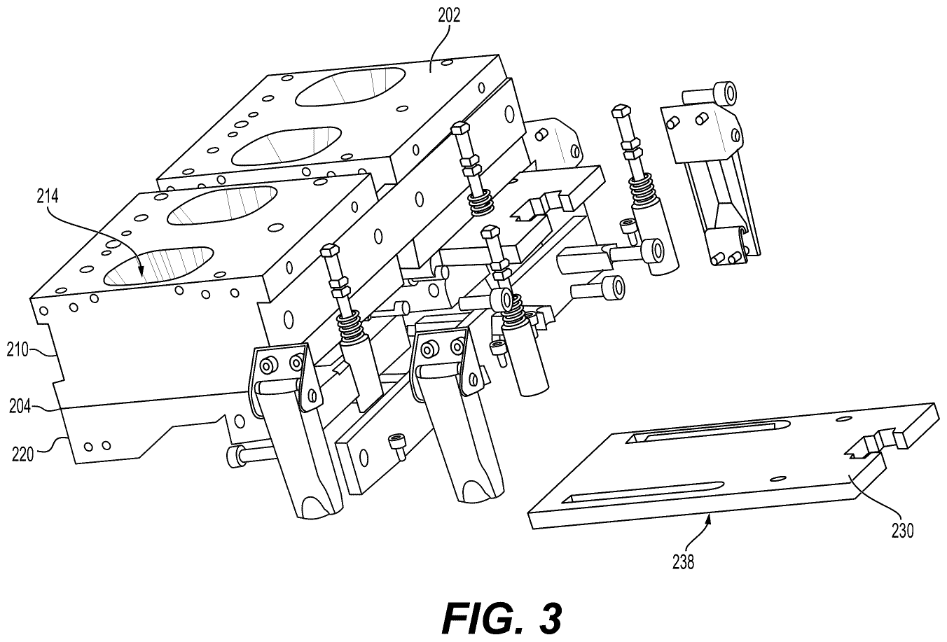

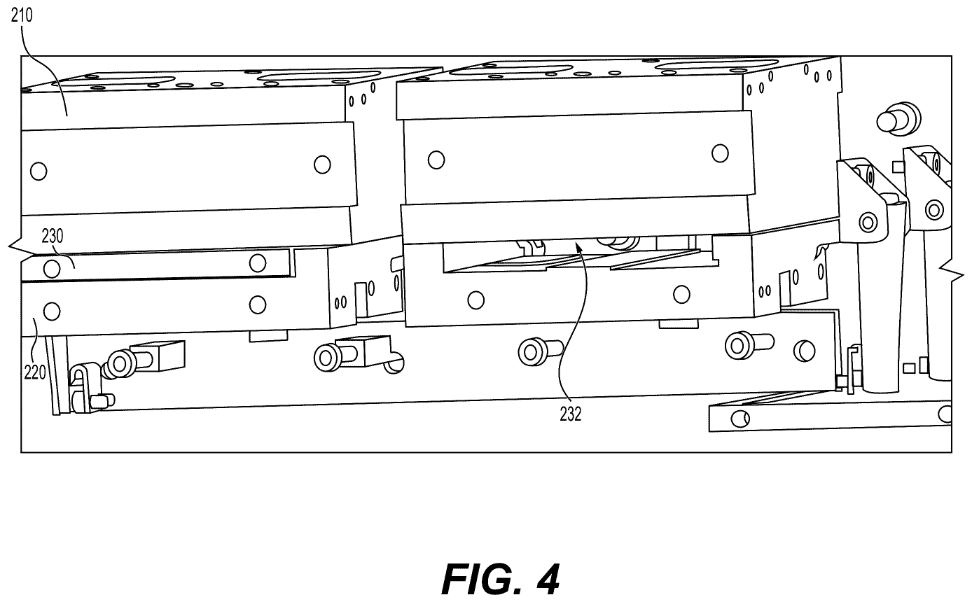

A bottom surface of the upper assembly 210 and a top surface of the lower assembly 220 collectively define a transverse conduit 232 (e.g., a slot) extending transversely, in relation to the continuous channel 290, between the upper assembly 210 and the lower assembly 220. As referred to herein, extending transversely (“transverse”) to a channel includes extending transversely to a longitudinal axis of the channel. In the example embodiments shown in FIGS. 3-4, for example, the upper surface of the lower assembly 220 includes a recess (e.g., a slot) that establishes the transverse conduit 232 between the recessed portion of the upper surface of the lower assembly 220 and a non-recessed lower surface of the upper assembly 210. It will be understood, however, that the transverse conduit 232 may be at least partially defined by a recessed portion of the lower surface of the upper assembly 210, in addition to or in alternative to a recessed portion of the upper surface of the lower assembly 220.

As further shown in FIGS. 1-2, the cutting assembly 230 is configured to adjustably extend through the transverse conduit 232 to move transversely in relation to (e.g., perpendicularly to) the longitudinal axis of the continuous channel 290. The cutting assembly 230 may extend (“move”) transversely through the continuous channel 290, between the upper channel 219 and the lower channel 229. For instance, rails may be disposed on the cutting assembly 230, thus facilitating the transverse movement. Further, the dosing system 100 may include an air cylinder 236 coupled to the cutting assembly 230, or the plate configured to reciprocate, such that the air cylinder 236 is configured to move the cutting assembly 230. In various embodiments, the air cylinder 236 is configured to reciprocate the cutting assembly 230 between a range of 10-50 mm (e.g., 30 mm). In various embodiments, air cylinder is configured to reciprocate the cutting assembly 230, or the plate, 50-100 times per minute.

In various embodiments, a material 238 may cover or surround a bottom surface of the cutting assembly 230. For instance, the bottom surface is in confronting relation with the lower assembly 220. The material 238 may comprise a polyethylene terephthalate (PET). The material 238 may acts like a gasket against the lower assembly 220. In various embodiments, the material 238 is the only portion of the cutting assembly 230 which is in contact with the lower assembly 220.

The cutting assembly 230 may further include an edge portion 234 that is configured to cut through any material that is located within the portion of the transverse conduit 232 that at least partially defines a portion of the continuous channel 290 between the upper channel 219 and the lower channel 229. It will be understood that the portion of the transverse conduit 232 that at least partially defines a portion of the continuous channel 290 may be considered to be a portion of a bottom end of the upper channel 219 and/or a portion of a top end of the lower channel 229.

In some example embodiments, as a result of the cutting assembly 230 extending transversely to the continuous channel 290, the cutting assembly 230 may isolate the lower channel 229 from the upper channel 219, such that an upper surface 231 of the cutting assembly 230 is in fluid communication with, and defines a bottom boundary of, the upper channel 219, and a lower surface 233 of the cutting assembly 230 is in fluid communication with, and defines a top boundary of, the lower channel 229.

In addition, where a bulk instance of compressed material extends through the upper channel 219 and the lower channel 229, and as a result of the cutting assembly 230 extending transversely to the continuous channel 290, the cutting assembly 230 may sever the lower material portion of the bulk instance (held in the lower channel 229) from the upper material portion of the bulk instance (held in the upper channel 219). For example, as noted above, the cutting assembly 230 may include an edge portion 234 that is configured to cut through the bulk instance of the compressed material based on the cutting assembly 230 moving transversely through the channel assembly 200 between the upper channel 219 and the lower channel 229.

The severed lower material portion may be referred to herein as a portioned instance of the compressible material. As a result, severing the lower material portion from the upper material portion may be referred to herein as producing the portioned instance of the compressible material, where the severed material portion is the portioned instance.

As shown in FIG. 2, the dosing system 100 may include a sealing plate 250 that is configured to move to reversibly seal or expose the bottom opening 226 of the channel assembly 200. The sealing plate 250 may be connected to the channel assembly 200 (e.g., slidably, hingedly via a hinge, or the like). The sealing plate 250 may not be directly connected to the channel assembly 200 and may be configured to move in relation to the channel assembly 200 to reversibly seal or expose the bottom opening 226 of the channel assembly 200.

Based on the sealing plate 250 sealing the bottom opening 226, the sealing plate 250 may restrict any compressible material held in at least the lower channel 229 of the channel assembly 200 to remain within the channel assembly 200. For example, the sealing plate 250 may be in a closed position in order to preclude compressible material from being forced through the bottom opening 226.

Referring still to FIGS. 1-2, and as additionally shown in FIGS. 3-4, the upper assembly 210 of the dosing system 100 includes a top surface 202. The top surface 202 may be coupled to the hopper 300. The upper assembly 210 further includes a bottom surface 204 opposite the top surface 202. For instance, the bottom surface 204 may be configured to be in confronting relation with the cutting assembly 230 when the dosing system 100 is in operation (e.g., when the upper assembly 210 is coupled to the lower assembly 220 and the cutting assembly 230 is moving within the transverse conduit 232 of the lower assembly 220).

In some example embodiments, the compressible material may have fluidic characteristics (e.g., may be “moist” and/or “wet”), such that the material may have a relatively high viscosity, and may be at least mildly adhesive to various surfaces (e.g., may be “sticky”). Such a material may at least partially adhere to portions of the dosing system 100. For example, the material may stick to the cutting assembly 230 which can slow down operation and create wear.

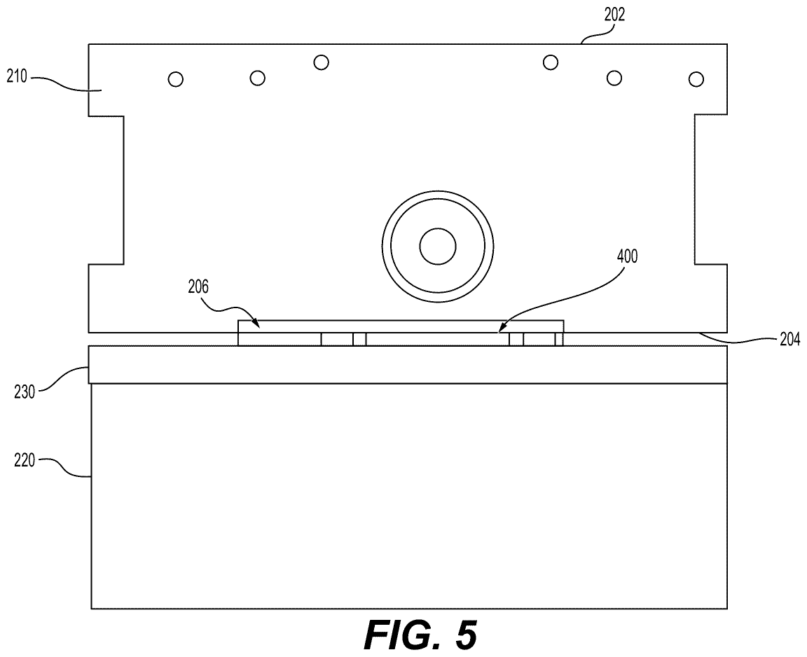

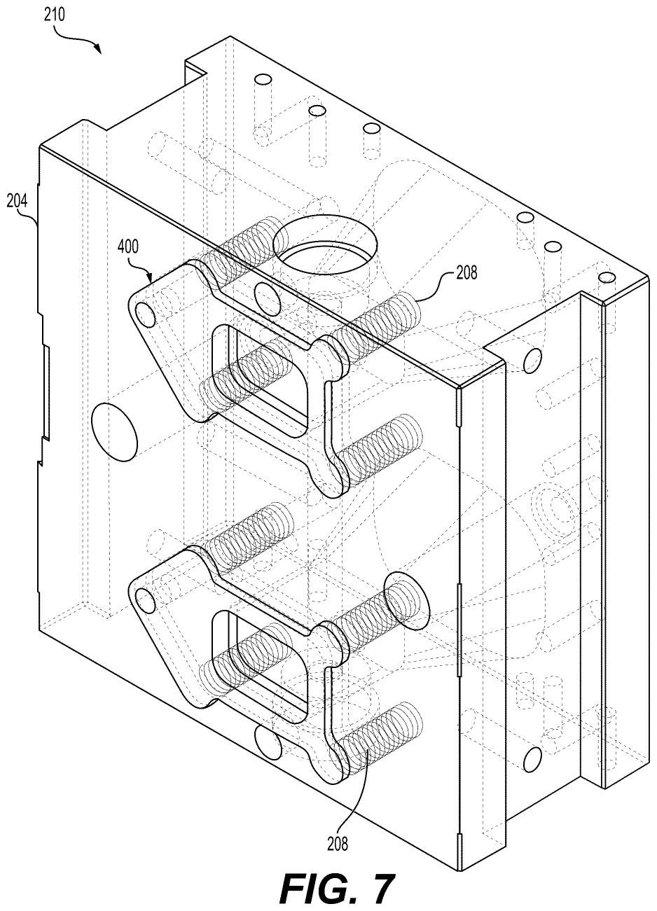

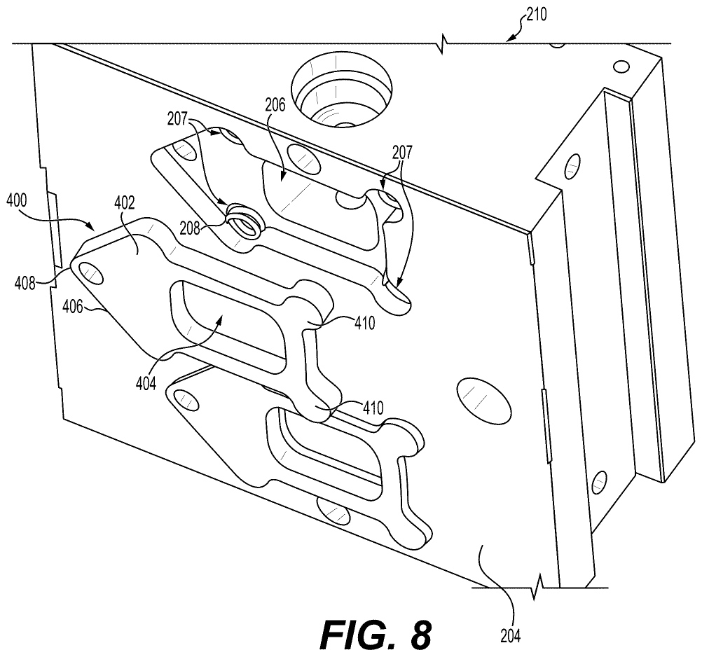

Accordingly, and referring now to FIGS. 5-8, the dosing system 100 includes an insert 400. The insert 400 is configured to minimize drag and wear while still minimizing the space between the upper assembly 210 and the cutting assembly 230, as is explained further herein. In various embodiments, the dosing system 100 may include more than one insert 400. For instance, as shown in FIGS. 7 and 8, the dosing system may include two inserts 400.

Referring particularly to FIG. 8, the insert 400 may include a body 402. The body 402 may be substantially in the shape of an arrow. However, in various embodiments, the body 402 may be any suitable shape (e.g., square, oval, oblong, etc.). In various embodiments, the body defines a central cavity 404. For instance, the central cavity 404 may be substantially rectangular. The insert 400 includes a head 406 (e.g., an arrowhead). The head 406 may be substantially triangular. For instance, the head 406 may provide a pointed end 408 of the insert 400. However, in various embodiments, the head 406 may be any suitable shape (e.g., square, oval, oblong, etc.). The insert 400 further comprises a plurality of feet 410. The plurality of feet 410 may extend from the body 402 opposite the head 406. In various embodiments, as shown in FIG. 8, the plurality of feet 410 may include two feet 410 which extend from the body 402 opposite the head 406. The plurality of feet 410 may be substantially circular. However, in various embodiments, the plurality of feet 410 may be any suitable shape (e.g., square, oval, oblong, etc.).

Referring still to FIG. 8, the bottom surface 204 of the upper assembly 210 may include a recessed portion 206. For instance, the recessed portion 206 may be a cut-out section of the upper assembly 210 such that there may be a gap, or a slot, between the bottom surface 204 and the cutting assembly 230. The recessed portion 206, as explained further herein, is configured (e.g., shaped) to receive the insert 400. In various embodiments, the upper assembly 210 includes more than one recessed portion 206. Accordingly, the dosing system 100 includes more than one insert 400, each recessed portion 206 corresponding with each insert 400.

The recessed portion 206 may be shaped to correspond with the shape of the inset 400. In various embodiments, the recessed portion 206 includes at least one recessed channel 207. As shown in FIG. 8, each recessed portion 206 includes four recessed channels 207. For instance, considering the shape of the recessed portion 206 corresponds with the shape of the insert 400, each of the recessed channels 207 are disposed in positions along the recessed portion 206 which correspond with (e.g., align with) positions of the body 402. Particularly, the recessed channels 207 may align with the plurality of feet 410 and corners of the head 406.

In various embodiments, the recessed portion 206 may be formed via electrical discharge machining (e.g., electrode electrical discharge machining). In various embodiments, the recessed portion 206 may be formed via computer numerical control machining.

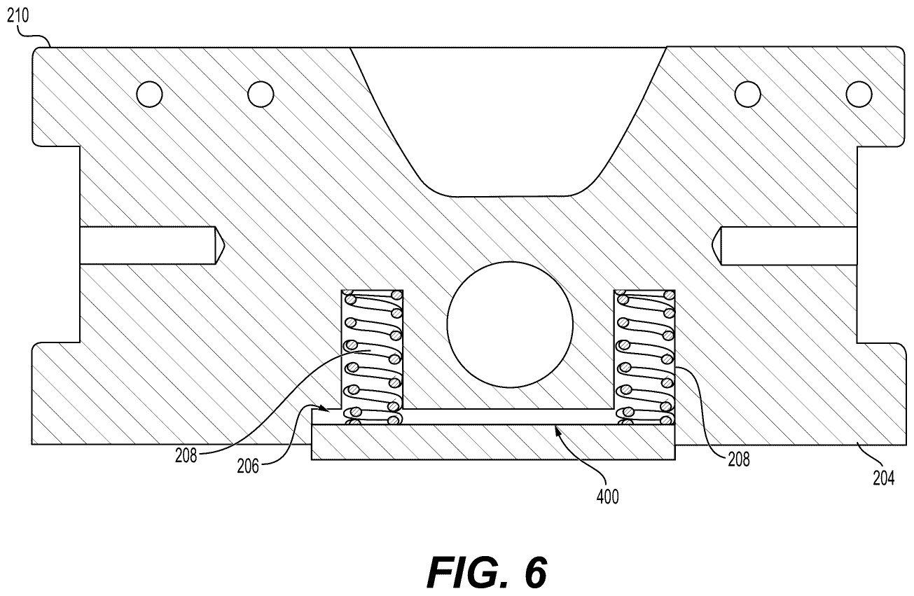

Referring now to FIGS. 6-8, the upper assembly 210 further includes at least one biasing member 208. The at least one biasing member 208 is configured to allow the insert 400 to compress into the recessed portion 206 such that the insert 400 is flush with the bottom surface 204. In various embodiments, the upper assembly 210 may include a plurality of biasing members 208. As shown in FIG. 7, each insert 400 includes four biasing members 208. The at least one biasing member 208 is preferably distributed evenly within the recessed portion 206, thus providing an evenly applied force, or uniform bias, to the insert 400. Each biasing member 208 is configured to be housed at least partially within each recessed channel 207. Each biasing member 208 extends from the recessed channel 207, thus allowing contact between the biasing member 208 and the insert 400 when the insert 400 is disposed within the recessed portion 206. In various embodiments wherein there are four biasing members 208 per insert 400, for example, four recessed channels 207 per recessed portion 206 are provided such that each of the biasing members 208 and individually housed in each of the recessed channels 207.

In various embodiments, the at least one biasing member 208 is a spring (e.g., a helical or coiled wire spring). In various embodiments, the at least one biasing member 208 may be a spring having a maximum load capacity, or strength, including a range of 5-10 lbs. (e.g., 6.5 lbs., 8 lbs., etc.) Accordingly, the insert 400 may be spring loaded against the cutting assembly 230 via the biasing member 208. The use of such a biased (e.g., spring-loaded) insert minimizes drag and wear while still minimizing the space between the upper assembly 210 and the cutting assembly 230.The clearance between the upper assembly 210 and the lower assembly 220 could allow the filler material to escape and become stuck between the upper assembly 210 and the cutting assembly 230, and between the lower assembly 220 and the cutting assembly 230. The escaped filler material can attach to all three components and creates sticking issues which requires the assembly to be taken apart and cleaned frequently. Accordingly, the insert 400 provides a clearance that can be increased between the upper assembly 210 and the lower assembly 220 while maintaining a constant pressure against the cutting assembly 230, thus reducing sticking caused by escaped filler material or buildup. For instance, the insert 400 may provide a lateral clearance of 5-10 mm.

In various embodiments, the insert 400 comprises a Polyether ether ketone (PEEK), an A2 tool steel, a D2 tool steel, or a diamond coating. In various embodiments, the insert 400 may be formed via electrical discharge machining (e.g., wired electrical discharge machine in embodiments wherein the insert 400 comprises a steel). In various embodiments, the insert 400 may be formed via computer numerical control machining (e.g., in embodiments wherein the insert 400 comprises PEEK).

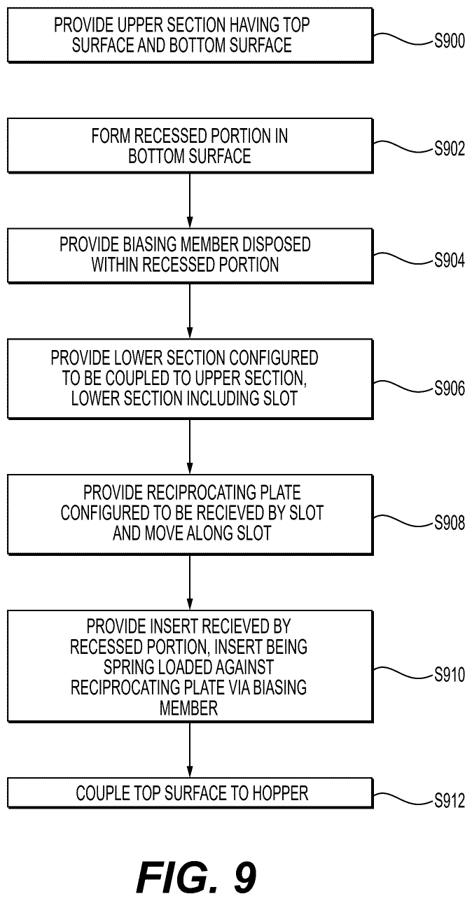

Referring now to FIG. 9, a method of forming a dosing system (e.g., dosing system 100) is provided. At S900, an upper assembly, or an upper section (e.g., upper assembly 210) is provided. The upper section includes a top surface (e.g., top surface 202) and a bottom surface (e.g., bottom surface 204). At S902, a recessed portion (e.g., recessed portion 206) is formed in the bottom surface. Further, at S904, a biasing member (e.g., biasing member 208) is disposed within the recessed portion. At S906, a lower assembly, or a lower section (e.g., lower assembly 220) is provided. The lower section is configured to couple to the upper section. The lower section includes a transverse conduit, or slot (e.g., transverse conduit 232). At S908, a cutting assembly, or a plate (e.g., cutting assembly 230) is provided and configured to be received by the transverse conduit. The plate is configured to move along the transverse conduit. At S910, an insert (e.g., insert 400) is provided and received by the recessed portion. The insert is spring loaded against the plate via the biasing member. At S912, the top surface is coupled to a hopper (e.g., hopper 300).

In various embodiments, the method 500 may include forming the recessed portion via electrical discharge machining. In various embodiments, the recessed portion via computer numerical control machining.

Example embodiments have been disclosed herein; it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A dosing system comprising:
an upper section having a top surface and a bottom surface, the top surface configured to be coupled to a hopper, the bottom surface defining a recessed portion and a biasing member housed within the recessed portion;
a lower section configured to be coupled to the upper section, the lower section including a slot;
a plate configured to be received by the slot and move along the slot; and
an insert received by the recessed portion, the insert being spring loaded against the plate via the biasing member.

2. The dosing system of claim 1, wherein the recessed portion includes a plurality of biasing members.

3. The dosing system of claim 1, wherein the slot has a lateral clearance of 5-10 mm.

4. The dosing system of claim 1, wherein the biasing member is configured to allow the insert to compress into the recessed portion such that the insert is flush with the bottom surface.

5. The dosing system of claim 1, further comprising:
a material surrounding a bottom surface of the plate, the bottom surface in confronting relation with the lower section.

6. The dosing system of claim 5, wherein the material comprises a polyethylene terephthalate.

7. The dosing system of claim 1, further comprising:
an air cylinder coupled to the plate, the air cylinder configured to move the plate in a reciprocating manner.

8. The dosing system of claim 7, wherein
the air cylinder is configured to reciprocate the plate 30 mm, and
the air cylinder is configured to reciprocate the plate 50-100 times per minute.

9. The dosing system of claim 1, wherein the insert comprises a Polyether ether ketone (PEEK), an A2 tool steel, a D2 tool steel, or a diamond coating.

10. The dosing system of claim 1, wherein the upper section comprises a first channel configured to receive a filler material from the hopper and the lower section comprises a second channel configured to receive the filler material from the upper section.

11. The dosing system of claim 10, wherein
the plate is configured to control flow of the filler material from the first channel to the second channel, and
the lower section includes packaging to receive the filler material.

12. A spring-loaded slide doser comprising:
a top stationary plate defining a recessed portion in a first surface;
a biasing member housed within the recessed portion;
a plate configured to slide horizontally with respect to the top stationary plate; and
an insert configured to be received by the recessed portion and biased against the plate via the biasing member.

13. The spring-loaded slide doser of claim 12, further comprising:
a bottom stationary plate.

14. The spring-loaded slide doser of claim 13, wherein the bottom stationary plate includes a slot configured to receive the plate.

15. The spring-loaded slide doser of claim 12, further comprising:
a plurality of biasing members housed within the recessed portion.

16. The spring-loaded slide doser of claim 12, wherein the biasing member is configured to allow the insert to compress into the recessed portion such that the insert is flush with the top stationary plate.

17. The spring-loaded slide doser of claim 12, wherein the insert comprises a Polyether ether ketone (PEEK), an A2 tool steel, a D2 tool steel, or a diamond coating.

18. The spring-loaded slide doser of claim 13, wherein
the top stationary plate comprises a first channel configured to receive a filler material from a hopper and the bottom stationary plate comprises a second channel configured to receive the filler material from the top stationary plate, and
the plate is configured to control flow of the filler material from the first channel to the second channel.

19. A method of forming a dosing system, the method comprising:
providing an upper section having a top surface and a bottom surface;
forming a recessed portion in the bottom surface;
providing a biasing member disposed within the recessed portion;
providing a lower section configured to be coupled to the upper section, the lower section including a slot;
providing a plate configured to be received by the slot and move along the slot;
providing an insert received by the recessed portion, the insert being spring loaded against the plate via the biasing member; and
coupling the top surface to a hopper.

20. The method of claim 19, wherein
forming the recessed portion comprises forming the recessed portion via electrical discharge machining, and
forming the recessed portion comprises forming the recessed portion via computer numerical control machining.
